(19) United States
(12) Patent Application Publication
(10) Pub. No.: US 2007/0242011 A1
(43) Pub. Date: Oct. 18, 2007

(54) Display Device

(75) Inventor: Tatsuya Kita, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/735,713

(22) Filed: Apr. 16, 2007

(30) Foreign Application Priority Data
Apr. 17, 2006 (JP) 2006-113509

(51) Int. Cl. G09G 3/36

(52) U.S. Cl. 345/87

(57) ABSTRACT

A source driver of a liquid crystal display device comprises: a display signal generation unit for generating drive signals to drive data lines based on data signals; a vertical back porch setting switch terminal connected to the display signal generation unit; a ground terminal set at a ground potential; and a power supply terminal set at a predetermined potential. The vertical back porch setting switch terminal is connected to either one of the ground terminal and the power supply terminal. The display signal generation unit can switch between two preset vertical back porch set values, depending on which of the ground terminal and the power supply terminal is connected to the vertical back porch setting switch terminal. This makes it possible to use the source driver in common in two kinds of liquid crystal panels with two different numbers of horizontal synchronous signals, i.e. two different numbers of scan lines.

### BACKGROUND OF THE INVENTION

1. Field of the Invention

The present invention relates to a display device such as a liquid crystal display device with a gate driver and a source driver for driving a display panel having multiple pixels.

2. Description of the Related Art

An example of a conventional display device mounted on an electronic apparatus uses a display panel, typically a liquid crystal display panel, having multiple pixels arranged in a matrix of rows and columns (refer to e.g. Japanese Laid-open Patent Publication 2004-233771). The liquid crystal display has scan lines arranged in rows and data lines arranged in columns to intersect each other, forming a matrix of intersections, in which each pixel is connected to one corresponding scan line and one corresponding data line at each of the intersections. Voltages are applied to the scan lines and the data lines at predetermined drive timings for driving the respective pixels. More specifically, drive voltages are applied to the scan lines based e.g. on vertical synchronous signals, while drive voltages are also applied to the data lines according to data signals generated based on e.g. horizontal synchronous signals and display data.

The drive voltages to the scan lines are applied by a gate driver. On the other hand, the drive voltages to the data lines are applied by a source driver which is formed e.g. of an ASIC (Application Specific Integrated 1′ Circuit). The source driver is an element to be considered here. The source driver is designed so that in a predetermined active data period after the elapse of a predetermined vertical back porch period following a vertical synchronous signal, a preset predetermined drive voltage according to a display data is applied to each data line, so as to allow the pixels in the data line to display in order of pixels from an end closest to the source driver (vertical end of the liquid crystal panel). Thus, the source driver drives each data line based on a preset predetermined vertical back porch period, i.e. a predetermined vertical back porch set value, so as to properly display an image adapted to the liquid crystal display panel used in the display device.

However, the conventional source driver has a problem that it cannot be used as a common component in multiple kinds of liquid crystal panels with different numbers of scan lines (namely, different numbers of horizontal synchronous signals). For example, assume the use of two liquid crystal panels, in which the number of scan lines (horizontal synchronous signals) of a first liquid crystal panel is smaller that that of a second one. Under this assumption, it is possible to use display data with the same specification for display on the first and second liquid crystal panels. However, if a source driver having a vertical back porch set value optimized for the first liquid crystal panel is used in the second liquid crystal panel, it is not possible to properly display an image on the second liquid crystal panel, for example, causing image positional deviation such that the center of the image is vertically shifted from the center of the second liquid crystal panel.

In this case, in order to properly display an image on the second liquid crystal panel, it is required to change the vertical back porch set value so as to allow the active data period to be adapted to the second liquid crystal panel. For this reason, if e.g. two kinds of liquid crystal panels with different numbers of scan lines (horizontal synchronous signals) from each other are used in the prior art, it is required to prepare two kinds of source drivers having vertical back porch set values different from each other so as to adapt the source drivers to the respective liquid crystal panels. Thus, the cost of the source driver (as a component), and hence of a display device, cannot be reduced e.g. by way of mass-producing source drivers of one kind.

On the other hand, it is also known to combine a source driver e.g. with a controller of an electronic apparatus having a display device (display panel) mounted thereon to use the controller of the electronic apparatus for changing the vertical back porch set value of the source driver so as to adapt the source driver to different kinds of liquid crystal panels. An example of such a source driver is designed e.g. to receive data for assigning a vertical back porch set value so that the source driver can change the vertical back porch set value based on the received data, making it possible to adapt one source driver to different kinds of liquid crystal panels. However, in order to be able to use such source driver, the controller of the electronic apparatus having the display device mounted thereon is required to be able to output data for assigning a vertical back porch set value. In other words, such source driver cannot be used for an electronic apparatus with a controller which cannot output data for assigning a vertical back porch set value.

Furthermore, in order to use such source driver, the combination of the source driver and the controller of the electronic apparatus are required to be designed so that the source driver can receive data for assigning a vertical back porch set value. This causes a problem of an increase in manufacturing cost. In addition, if the display device (display panel) is manufactured by a manufacturer different from that of the electronic apparatus on which the display device is mounted, there may be a problem that the manufacturer of the display device (display panel) cannot access or know the content of the data to be output from the controller of the electronic apparatus for assigning the vertical back porch set value. Note in this connection that the above-described Japanese Laid-open Patent Publication 2004-233771 describes a source driver which sets a vertical back porch set value based on a preset value stored in a first-scan-line assignment register. However, at the same time, it uses e.g. a counter for making the scan line variable or changeable. This leads to a complicated circuit structure, so that the technology described therein does not provide an effective solution to the problem described above.

### SUMMARY OF THE INVENTION

An object of the present invention is to provide a display device which can adapt a source driver in common to multiple kinds of display panels different from each other in the number of scan lines (horizontal synchronous signals), thereby reducing the cost of the source driver as a component, and hence the manufacturing cost of the display device.

According to the present invention, this object is achieved by a display device comprising: a display panel comprising (i) a matrix of multiple pixels arranged in rows and columns intersecting each other, (ii) scan lines arranged in rows each to be connected to ones of the pixels arranged in each same row; and (iii) data lines arranged in columns each to be connected to ones of the pixels arranged in each same column; a controller for sending synchronous signals and display data; a gate driver connected to the display panel for driving the scan lines based on the synchronous signals received from the controller; and a source driver connected to the display panel for driving the data lines based on the synchronous signals and the display data received from the controller.

The source driver comprises: a vertical back porch setting switch means for switching a vertical back porch set value between multiple preset vertical back porch set values; and a vertical back porch setting switch terminal connected to the vertical back porch setting switch means, wherein based on voltage of the vertical back porch setting switch terminal, the vertical back porch setting switch means selects, from the multiple preset vertical back porch set values, a vertical back porch set value for driving the data lines.

The display device according to the present invention operates such that based on voltage of the vertical back porch setting switch terminal, the vertical back porch setting switch means selects, from the multiple preset vertical back porch set values, a vertical back porch set value for driving the data lines. Accordingly, the source driver can change the vertical back porch set value used for driving the data lines, depending on the display panel for which the source driver is used. This makes it possible to use one source driver in common in multiple different kinds of display panels, making it possible to reduce the cost of the source driver as a component, and hence reduce the manufacturing cost of the display device, by mass-producing the source drivers of one kind. Furthermore, in contrast to the prior art, it becomes unnecessary to access or know the content of data to be output from a controller of an electronic apparatus for assigning or selecting the vertical back porch set value, even if the display device is produced by a manufacturer different from that of the electronic apparatus on which the liquid crystal display device is to be mounted.

Preferably, the source driver further comprises multiple selection terminals respectively set at different predetermined potentials from each other, wherein the vertical back porch setting switch terminal is connected to either one of the selection terminals corresponding to a vertical back porch set value adapted to a display panel to be used, so as to allow the source driver to drive the data lines by using the vertical back porch set value adapted to the display panel to be used.

Further preferably, the display device further comprises a power supply circuit for supplying power to the gate driver and the source driver, wherein the source driver comprises a ground terminal and a power supply terminal which is connected to the power supply circuit and is set at a predetermined potential, and wherein the vertical back porch setting switch terminal is connected to either one of the ground terminal and the power supply terminal, so as to allow the vertical back porch setting switch means to switch between two preset vertical back porch set values, depending on which of the ground terminal and the power supply terminal is connected to the vertical back porch setting switch terminal.

The display panel to be used in the display device can be a liquid crystal panel.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic block diagram of an example of a liquid crystal display device according to an embodiment of the present invention;

FIG. 2 is a schematic block diagram of a source driver of the liquid crystal display device; and

FIG. 3 is a schematic view showing two different numbers of horizontal synchronous signals (scan lines) corresponding to two different kinds of liquid crystal panels each with the same source driver according to the embodiment of the present invention.

### DESCRIPTION OF THE PREFERRED EMBODIMENTS

Embodiments of the present invention, as best mode for carrying out the invention, will be described hereinafter with reference to the drawings. The present invention relates to a display device. It is to be understood that the embodiments herein are not intended as limiting, or encompassing the entire scope of, the invention. Note that like parts are designated by like reference numerals or characters throughout the drawings.

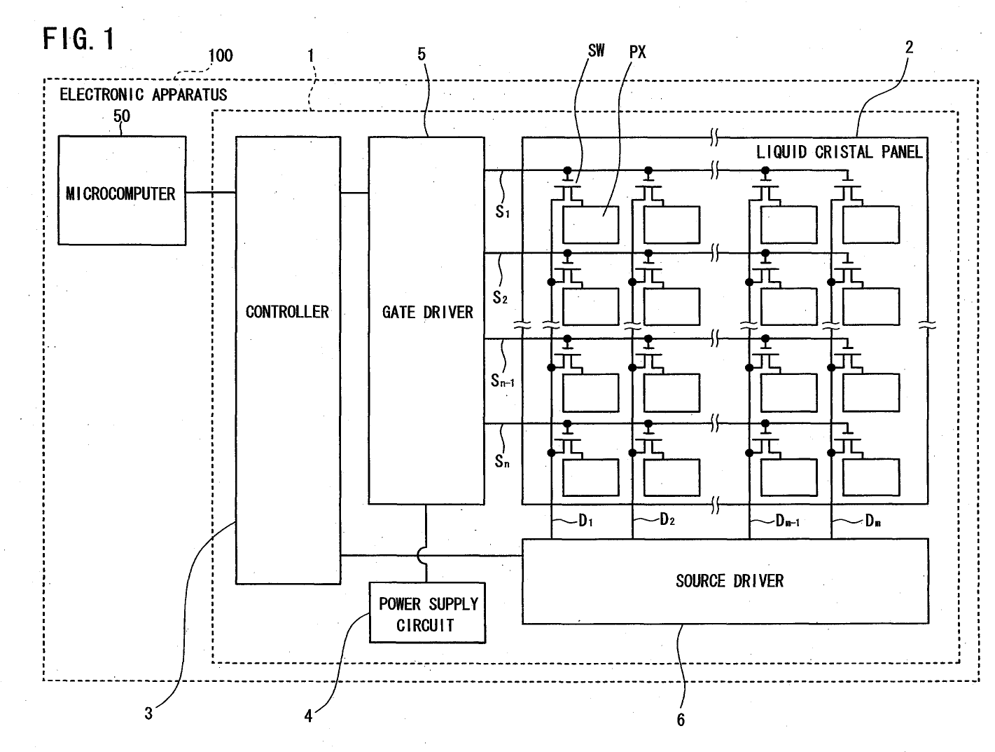

FIG. 1 is a schematic block diagram of an example of a liquid crystal display device 1 (claimed “display device”) according to an embodiment of the present invention. The liquid crystal display device 1 is mounted e.g. on an electronic apparatus 100 such as a printer. The electronic apparatus 100 is designed to allow the liquid crystal device 1 to display and notify e.g. operating information of the electronic apparatus 100 to a user. Note that the electronic apparatus 100 is not limited e.g. to a printer. The liquid crystal display device 1 according to the present embodiment is e.g. of a so-called active matrix type, and comprises a liquid crystal panel 2 (claimed “display panel”), a controller 3, a power supply circuit 4, a gate driver 5 and a source driver 6. The liquid crystal display device 1 is connected e.g. to a microcomputer 50 provided in the electronic apparatus 100, and displays an image on the liquid crystal panel 2 based on an image signal or display data sent from the microcomputer 50.

The liquid crystal panel 2 comprises (i) a matrix of n×m pixels PX arranged in n rows and m columns intersecting each other, (ii) scan lines S₁ to Sₙ arranged in n rows each to be connected to ones of the pixels PX arranged in each same row, (iii) data lines D₁ to Dₘ arranged in m columns intersecting the scan lines S₁ to Sₙ and each to be connected to ones of the pixels PX arranged in each same column, and (iv) n×m switching elements SW. That is, the number of scan lines S₁ to Sₙ corresponds to the number of pixels PX in each column, while the number of data lines D₁ to Dₘ corresponds to the number of pixels PX in each row. Each of the switching elements SW is e.g. a thin film transistor (TFT), and is provided corresponding to each of the pixels PX so as to connect each pixel PX to a corresponding one of the scan lines S₁ to Sₙ and a corresponding one of the data lines D₁ to Dₘ. In other words, each scan line is connected to the m pixels in the corresponding row, while each data line is connected to the n pixels in the corresponding column. Note that according to the present embodiment, the liquid crystal panel 2 as a primary example has a screen size e.g. of 1.7 inches with e.g. 240 scan lines (n=240).

The controller 3 is formed e.g. of an ASIC (Application Specific Integrated Circuit). The controller 3 subjects image signals input from the microcomputer 50 (provided in the electronic apparatus 100 and outside the liquid crystal display device 1) to signal processing, and outputs synchronous signals (vertical and horizontal synchronous signals) and display data for displaying an image on the liquid crystal panel 2. The synchronous signals are sent to the gate driver 5 and the source driver 6, while the display data are sent to the source driver 6. The power supply circuit 4 is supplied with power from a power supply circuit (not shown) of the electronic apparatus 100 so as to, in turn, supply power for driving the liquid crystal panel 2 to the gate driver 5 and the source driver 6. The gate driver 5 is also formed e.g. of an ASIC. The gate driver 5 is connected to the controller 3 so as to receive the synchronous signals from the controller 3, and apply drive voltages to the respective scan lines S₁ to Sₙ at drive timings based on the synchronous signals for driving the respective switching elements SW.

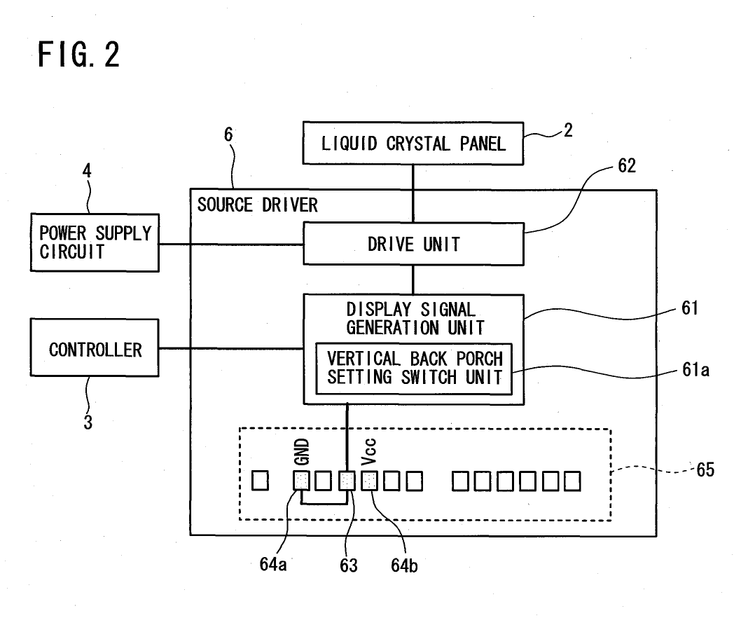

FIG. 2 is a schematic block diagram of the source driver 6 of the liquid crystal display device 1. The source driver 6 is also formed e.g. of an ASIC, and comprises: a display signal generation unit 61 connected to the controller 3 and including a vertical back porch setting switch unit 61a (claimed “vertical back porch setting switch means”) for switching between set values of vertical back porch periods (or for selecting a vertical back porch set value from multiple preset vertical back porch set values); and a drive unit 62 connected to the power supply circuit 4, the display signal generation unit 61 (vertical back porch setting switch unit 61a), and the liquid crystal panel 2. As shown in FIG. 2, the source driver 6 further comprises a terminal unit 65 formed of a plurality of terminals exposed outside.

The terminal unit 65 comprises: a ground terminal 64a set at a ground potential or voltage (0 V; GND) as a predetermined potential; a power supply terminal 64b connected to the power supply circuit 4 and set at a power supply voltage or potential of the source driver 6 (e.g. 3.3 V; Vcc) as another predetermined potential different from the ground potential; and a vertical back porch setting switch terminal (hereafter referred to simply as “switch terminal”) 63 connected to the display signal generation unit 61 (vertical back porch setting switch unit 61a) for switching between vertical back porch set values (switching between the ground terminal 64a and the power supply terminal 64b). The ground terminal 64a and the power supply terminal 64b are claimed “selection terminals” wherein in normal mode, the switch terminal 63 is connected to the ground terminal 64a.

The display signal generation unit 61 receives the synchronous signals and display data from the controller 3. Based on the horizontal synchronous signals and display data, the display signal generation unit 61 generates data signals for driving the respective data lines D₁ to Dₘ. As will be described later, the display signal generation unit 61 (vertical back porch setting switch unit 61a) generates the data signals based on a predetermined vertical back porch set value corresponding to or adapted to the (kind of) liquid crystal panel 2. For example, one (one kind of) liquid crystal panel 2 is set to have a vertical back porch period starting from the trailing edge of a vertical synchronous signal until the elapse of 12 HSYNC (twelve horizontal synchronous signals) or 12H (twelve scan lines) from the trailing edge, and is also set to have an active data period of 240 HSYNC (240H) after the elapse of the vertical back porch period. Here, the active data period is a period during which voltages are applied to the respective pixels PX for display. On the other hand, based on the thus generated data signals, the drive unit 62 generates drive voltages from the power source supplied by the power supply circuit 4, and applies the thus generated drive voltages to, and for driving, the respective data lines D₁ to Dₘ of the liquid crystal panel 2. Here, each drive voltage is a gradation voltage (tone voltage) which allows each corresponding pixel PX to have a predetermined gradation (tone) according to each data signal.

The respective pixels PX of the liquid crystal panel 2 are driven when the scan lines S₁ to Sₙ and the data lines D₁ to Dₘ are driven. More specifically, when the drive voltages are applied to the scan lines S₁ to Sₙ so as to drive the switching elements SW while the gradation voltages are applied to the data lines D₁ to Dₘ, the gradation voltages applied to the data lines D₁ to Dₘ are applied to the pixels PX. Based on the synchronous signals and the vertical back porch set value, the drive timings of the scan lines S₁ to Sₙ are synchronized with the drive timings and the gradation voltages of the data lines D₁ to Dₘ, so as to apply gradation voltages according or corresponding to the display data to the respective pixels PX. This allows the respective pixels PX to be driven to display predetermined gradations (tones) corresponding to the applied gradation voltages. In other words, the data lines D₁ to Dₘ are driven according to the drive timings of the scan lines S₁ to Sₙ based on an appropriate or proper vertical back porch set value adapted to the liquid crystal panel 2, so as to properly display an image corresponding to the display data on the liquid crystal panel 2.

In the present embodiment, two vertical back porch periods, namely two kinds of predetermined vertical back porch set values, are preset and stored in the display signal generation unit 61 (vertical back porch setting switch unit 61a). The two (two kinds of) vertical back porch set values are set to be adapted to the specifications or requirements of two kinds of liquid crystal panels 2 (more specifically with two different numbers of scan lines or horizontal synchronous signals) which use the same source driver 6. The display signal generation unit 61 (vertical back porch setting switch unit 61a) assigns or selects one of the two vertical back porch set values (to be used for driving the data lines D₁ to Dₘ), depending on which of the ground terminal 64a and the power supply terminal 64b in the terminal unit 65 is connected to the switch terminal 63 (i.e. which of the two voltages, either voltage of the ground terminal 64a or voltage of the power supply terminal 64b, is applied to the switch terminal 63). In other words, based on either of the two kinds of vertical back porch set values assigned by the display signal generation unit 61 (vertical back porch setting switch unit 61a) according to the voltage of the switch terminal 63, the drive unit 62 applies gradation voltages to, and thereby drive, the respective data lines D₁ to Dₘ.

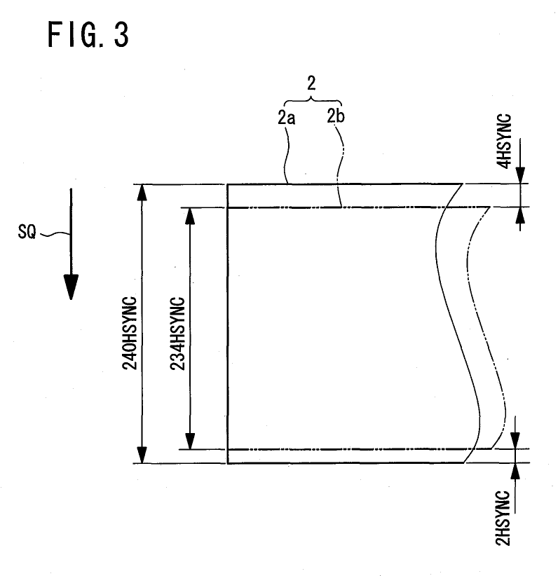

Referring also to FIG. 3 which is a schematic view showing two different numbers (240 and 234) of horizontal synchronous signals (HSYNC) or scan lines corresponding to two different kinds of liquid crystal panels 2 each with the same source driver 6 according to the liquid crystal display device 1 of the present embodiment, switching between (or selection of one of) the vertical back porch set values performed by the display signal generation unit 61 (vertical back porch setting switch unit 61a) will be described hereinafter. Here, it is assumed that a liquid crystal panel 2a as a primary example has 240 scan lines or HSYNC (n=240) with a screen size of 1.7 inches, while a liquid crystal panel 2b as another example has 234 scan lines or HSYNC (n=234) with a screen size of 2.4 inches. Based on the horizontal synchronous signals, the gate driver 5 drives the scan lines S₁ to Sₙ sequentially in the direction of arrow SQ in FIG. 3. The following describes how the display signal generation unit 61 (vertical back porch setting switch unit 61a) switches between the two vertical back porch set values to assign one of the two values.

In the two vertical back porch set values which are preset in the display signal generation unit 61 (vertical back porch setting switch unit 61a), the one corresponding to the liquid crystal panel 2a having the active data period of 240 HSYNC is referred to herein as a first set value, while the other corresponding to the liquid crystal panel 2b having the active data period of 234 HSYNC is referred to as a second set value. The first and second set values cause the corresponding vertical back porch periods to be 12 HSYNC and 16 HSYNC, respectively. Further, the first and second set values are related to the voltages 0 V (GND) and 3.3 V (Vcc) of the switch terminal 63, respectively. Referring to FIG. 2, the switch terminal 63 is connected to the ground terminal 64a in normal mode as described above? the voltage of which is 0 V. This allows the display signal generation unit 61 (vertical back porch setting switch unit 61a) to select (output) the first set value corresponding to the voltage 0 V as a vertical back porch set value to be used for the drive unit 62 to drive the data lines D₁ to Dₘ. That is, the source driver 6 is set in a mode where the switch terminal 63 is connected to the ground terminal 64a so as to drive the data lines D₁ to Dₘ based on a vertical back porch set value adapted to the liquid crystal panel 2a to be used.

On the other hand, when the liquid crystal panel 2b with 234 HSYNC, as indicated by the dashed double-dotted line in FIG. 3, is used as a liquid crystal panel 2 in the liquid crystal display device 1, the source driver 6 is set in a mode where the switch terminal 63 is connected to the power supply terminal 64b. In other words, the source driver 6 is set in the mode where the data lines D₁ to Dₘ are driven with the second set value adapted to the liquid crystal panel 2b to be used. This makes it possible to allow the same source driver 6 to properly display an image on the liquid crystal panel 2b similarly as in the case of the liquid crystal panel 2a with 240 HSYNC, in which the number of scan lines or horizontal synchronous signals in the case of the liquid crystal panel 2b is adjusted relative to that in the case of the liquid crystal panel 2a. More specifically, since the vertical back porch period in the case of the second set value is 16 HSYNC which is longer by 4 HSYNC than that in the case of the first set value, the active data period in the case of the liquid crystal panel 2b begins 4 HSYNC later than in the case of the liquid crystal panel 2a. Further, since the active data period in the liquid crystal panel 2b is formed of 234 HSYNC, this active data period having begun 4 HSYNC later ends 2 HSYNC earlier than in the case of the liquid crystal panel 2a with 240 HSYNC.

As described in the foregoing, according to the present embodiment, the connection of the switch terminal 63 is switched between the ground terminal 64a and the power supply terminal 64b, namely whether the switch terminal 63 is connected to the ground terminal 64a or the power supply terminal 64b, depending on the kind of liquid crystal panel 2 (2a, 2b) used in the liquid crystal display device 1. This makes it possible to drive the data lines D₁ to Dₘ by using a vertical back porch set value adapted to the liquid crystal panel 2 (2a, 2b). Thus, it becomes possible to use one source driver 6 in common in two different kinds of liquid crystal panels 2a, 2b, thereby making it possible to reduce the cost of the source driver 6 as a component, and hence reduce the manufacturing cost of the liquid crystal display device 1, by mass-producing the source drivers 6 of one kind.

Furthermore, since both ground terminal 64a and power supply terminal 64b are provided in the source driver 6, it is possible to set the source driver 6 in advance by connecting the switch terminal 63 to either of the terminals 64a, 64b depending on the kind of liquid crystal panel 2 to be used, either 2a or 2b, so that the source driver 6 can drive the data lines D₁ to Dₘ by using a proper vertical back porch set value adapted to the liquid crystal panel 2a or 2b. This makes it possible to more easily manufacture the liquid crystal display device 1. In addition, in contrast to the prior art, it becomes unnecessary to access or know the content of the data to be output from the controller of the electronic apparatus 100 for assigning the vertical back porch set value, even if the liquid crystal display device 1 is produced by a manufacturer different from that of the electronic apparatus 100 on which the liquid crystal display device 1 is to be mounted.

It is to be noted that the present invention is not limited to the above-described specific embodiments, and various modifications can be made within the scope of the present invention. For example, the drive unit can be designed to switch not only between two vertical back porch set values, but also between three or more vertical back porch set values, using the corresponding number (three or more) of voltages of the switch terminal. It is also possible to connect the switch terminal, not to the terminals in the terminal unit of the source driver, but e.g. to an external circuit (outside the source driver) which generates multiple output voltages, and to allow the source driver to switch between multiple vertical back porch set values based on the multiple output voltages.

In addition, the present invention can be applied not only to the above-described liquid crystal display device 1 using a liquid crystal panel of an active matrix type, but also to a liquid crystal display device using a liquid crystal panel of a passive matrix type, or even a display device using an organic EL (electro-luminescence) display panel as long as it has multiple pixels arranged in a matrix of rows and columns. Also in the case of such display devices, one source driver can be used in common in multiple kinds of display panels by allowing the source driver to switch between multiple preset vertical back porch set values based on multiple voltages of a switch terminal, thereby making it possible to reduce the manufacturing cost of each display device.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2006-113509 filed Apr. 17, 2006, the content of which is hereby incorporated by reference.

What is claimed is:

1. A display device comprising:
a display panel comprising (i) a matrix of multiple pixels arranged in rows and columns intersecting each other, (ii) scan lines arranged in rows each to be connected to ones of the pixels arranged in each same row; and (iii) data lines arranged in columns each to be connected to ones of the pixels arranged in each same column;
a controller for sending synchronous signals and display data;
a gate driver connected to the display panel for driving the scan lines based on the synchronous signals received from the controller; and
a source driver connected to the display panel for driving the data lines based on the synchronous signals and the display data received from the controller,
the source driver comprising:
a vertical back porch setting switch means for switching a vertical back porch set value between multiple preset vertical back porch set values; and
a vertical back porch setting switch terminal connected to the vertical back porch setting switch means,
wherein based on voltage of the vertical back porch setting switch terminal, the vertical back porch setting switch means selects, from the multiple preset vertical back porch set values, a vertical back porch set value for driving the data lines.

2. The display device according to claim 1,
wherein the source driver further comprises multiple selection terminals respectively set at different predetermined potentials from each other, and
wherein the vertical back porch setting switch terminal is connected to either one of the selection terminals corresponding to a vertical back porch set value adapted to a display panel to be used, so as to allow the source driver to drive the data lines by using the vertical back porch set value adapted to the display panel to be used.

3. The display device according to claim 2, wherein the display panel is a liquid crystal panel.

4. The display device according to claim 1,
which further comprises a power supply circuit for supplying power to the gate driver and the source driver,
wherein the source driver comprises a ground terminal and a power supply terminal which is connected to the power supply circuit and is set at a predetermined potential, and
wherein the vertical back porch setting switch terminal is connected to either one of the ground terminal and the power supply terminal, so as to allow the vertical back porch setting switch means to switch between two preset vertical back porch set values, depending on which of the ground terminal and the power supply terminal is connected to the vertical back porch setting switch terminal.

5. The display device according to claim 4, wherein the display panel is a liquid crystal panel.

6. The display device according to claim 1, wherein the display panel is a liquid crystal panel.
